(19) United States
(12) Patent Application Publication
(10) Pub. No.: US 2011/0047091 A1
(43) Pub. Date: Feb. 24, 2011

(54) METHOD AND SYSTEM FOR MAINTAINING CUSTOMS COMPLIANCE WHEN IMPORTING AND EXPORTING GOODS

(75) Inventors: Rajiv Manucha, Toronto (CA); Steven Lloyd Crozier, Toronto (CA); Antonio Giuliano, Bolton (CA)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: MANAGEMENT SYSTEMS RESOURCES, INC., Toronto (CA)

(21) Appl. No.: 12/544,836

(22) Filed: Aug. 20, 2009

(51) Int. Cl. G06Q 30/00

(52) U.S. Cl. 705/331

(57) ABSTRACT

A system and method which utilize current, updated classification of goods and parties when relevant documents are prepared and printed and further updates relevant classification data contained in various records either periodically or as changes are received. This updating and utilization of the current, updated classification minimizes delays which would occur because of improper characterization or classification information.

### BACKGROUND OF THE INVENTION

1. Field of the Invention

This invention relates to importing and exporting goods, and more particularly to a method apparatus for providing frequent compliance checking of documentation and paperwork.

2. Description of the Related Art

The importing and exporting of goods across jurisdictional boundaries, such as between states or nations, is a well known phenomena as a result of increased globalization, free trade agreements and the rise of multinational corporations. Trading goods across borders continues to grow and accelerate. One step of the process which is common in both importing and exporting is that certain information must be provided to allow proper passage of the goods. This information includes classification and parties. One characteristic of the import and export procedures is that classification information and party information may change periodically. However, in current systems there is no convenient mechanism to update the classification of either parties or goods in existing systems. As a result, in many cases goods are transferred with improper classifications. This often results in undesirable delays, either at the export or at the import stage. As these delays increase the cost for all parties involved, it would be desirable if a system was available which maintained current classification information for both goods and parties and updated itself as classification changes were provided by any of the relevant government entities.

### SUMMARY OF THE INVENTION

A system and method according to the present invention utilize current, updated classification of goods and parties when relevant documents are prepared and printed and further updates relevant classification data contained in various records either periodically or as changes are received. This updating and utilization of the current, updated classification minimizes delays which would occur because of improper characterization or classification information.

### BRIEF DESCRIPTION OF THE FIGURES

FIG. 1 is a block diagram of a computer system for operating the current method according to the present invention.

FIGS. 2A-2G are block diagrams of the computers of FIG. 1.

FIG. 3 is a flowchart of an embodiment of the import and export process according to the present invention.

FIG. 4 is a flowchart of the entry of goods information according to the present invention.

FIG. 5 is a flowchart of the entry of party information according to the present invention.

FIG. 6 is a flowchart of a periodic scan performed to update relevant information according to the present invention.

FIG. 7 is a flowchart of the updating of underlying information on goods and parties as changes to relevant data is received according to the present invention.

### DETAILED DESCRIPTION OF THE PREFERRED EMBODIMENT

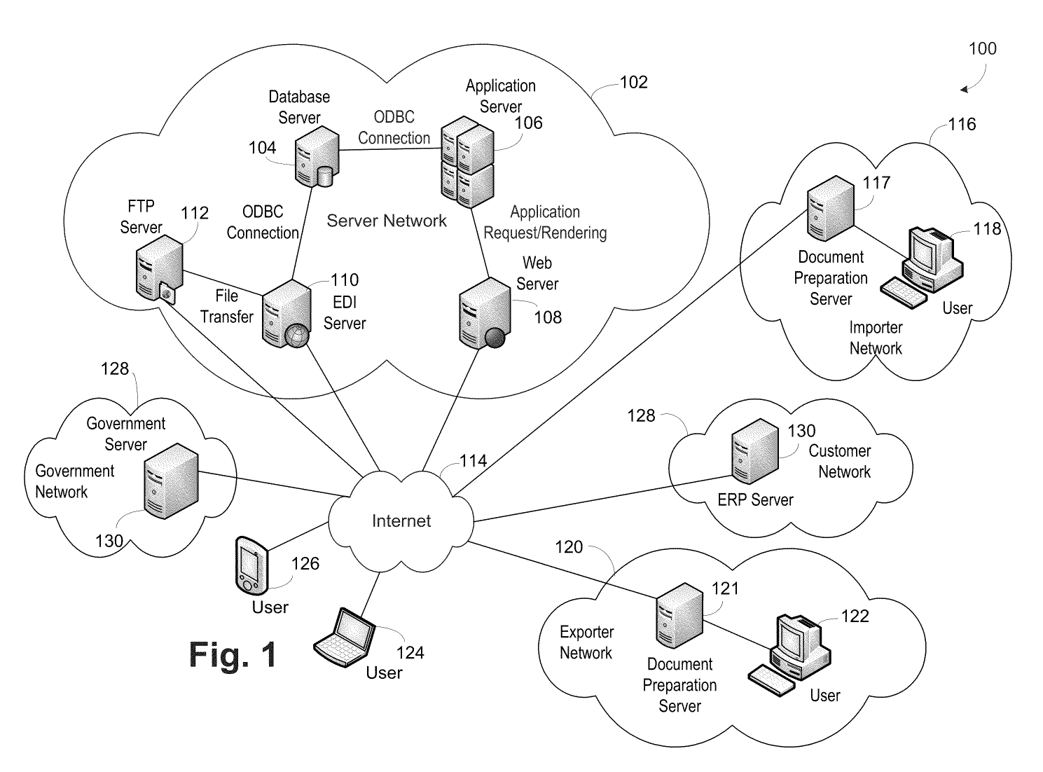

Proceeding now to FIG. 1, a system for maintaining current compliance of classification information, both for goods and for parties, is illustrated. The system 100 is divided into several different sections. A server network 102 is provided and contains the servers utilized according to the preferred embodiment of the present invention. These servers include a database server 104, an application server 106, a web server 108, an EDI server 110 and an FTP server 112. The database server 104 maintains the relevant records and tables for import/export transactions. The application server 106 stores and provides the basic logic and software implementing the logic to perform the basic application or method. The web server 108 acts as an interface between the various users of the system, be they importer/exporters or general users, and the application server 106. The EDI server 110 is used to receive and provide electronic data format information for use in maintaining various records. The FTP server 112 is preferably used for file transfer, one example in the illustrated embodiment being with the government entities which maintain various regulations relating to classification of goods and parties and another example being with document preparation servers of importers or exporters. The server network 102 is generally connected to the internet 114. Generally the web server 108, the EDI server 110 and the FTP server 112 are the servers which are connected to the internet. An importer network 116 is connected to the internet with an exemplary document preparation server 117 and an exemplary user computer 118 for the importer illustrated. Similarly, an exporter network 120 including an exemplary document preparation server 121 and an exemplary user 122 are also connected to the internet to allow access to the server network 102. In addition, individual users 124 and 126 can be directly connected to the internet 114 via any desirable method such as WAN connections and the like. A government network 128 includes a government server 130 which is connected via the internet 114 to the FTP server 112 to allow updates of classification information as needed to keep the data current in the system 100. A customer network 128 may contain an ERP server 130 which contains basic goods and party information of the customer. The ERP server 130 is connected to the internet 114.

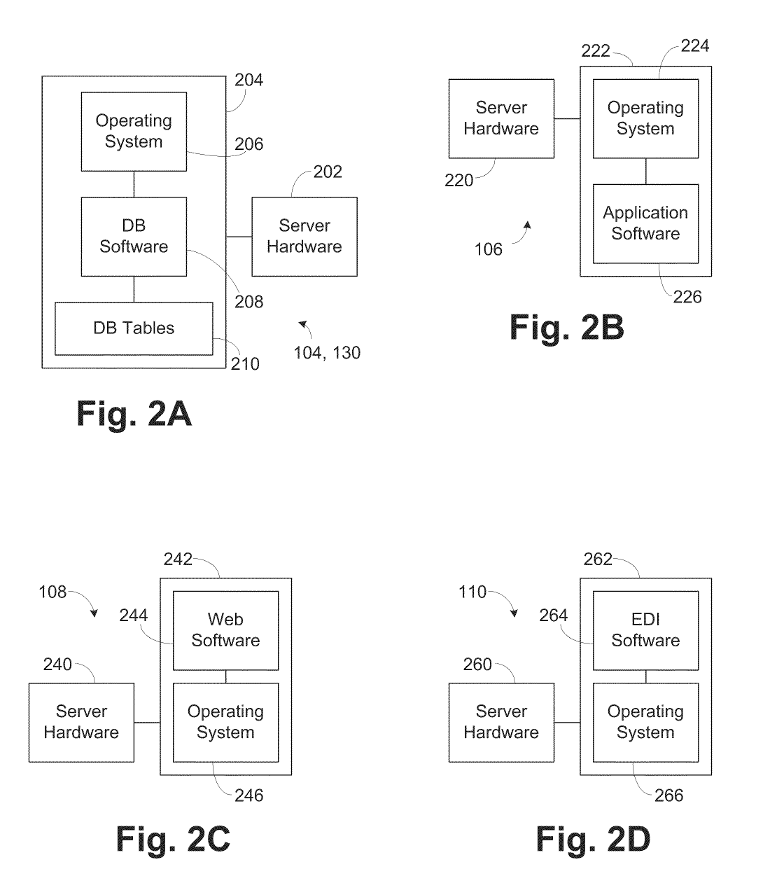

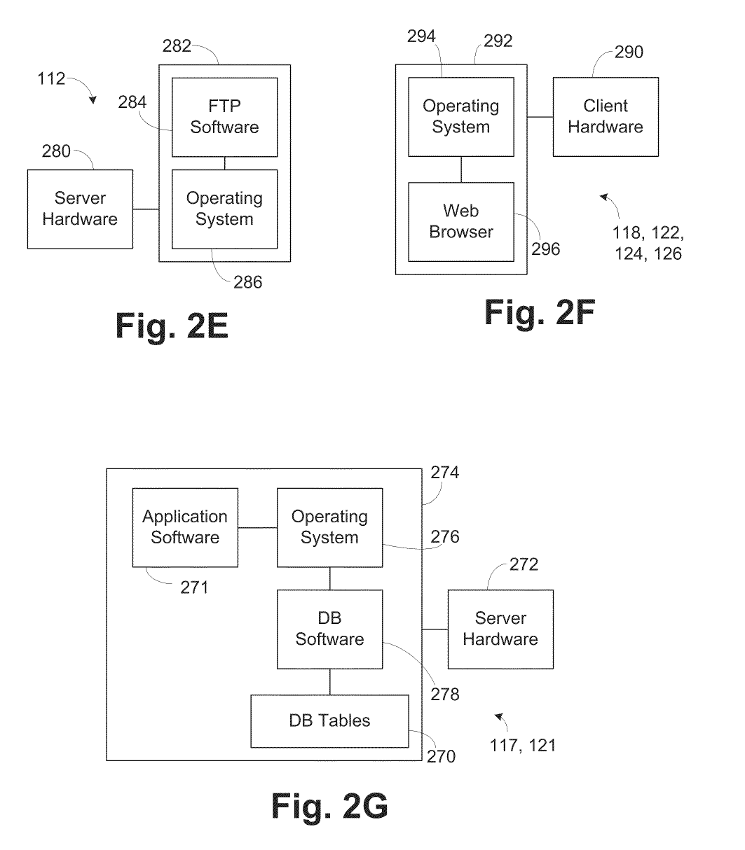

FIGS. 2A-2G are block diagrams of computers utilized in FIG. 1. FIG. 2A is a block diagram of the database server 104. The database server 104 includes server hardware 202 and a storage unit 204 for programs, instructions and data 204. The stored programs, instructions and data include an operating system 206, database software 208 and database tables 210. The block diagram of the ERP server 130 is essentially identical, the ERP system being similar to a database. The operating system 206 can be any desired operating systems such as Windows server or Linux. The database software 208 can be any desired database software such Microsoft SQL server, Oracle, MySQL and the like. The database table 210 contains information utilized to contain party and goods information and to maintain information on the transactions and transfers occurring.

The application server 106 is illustrated in FIG. 2B. Server hardware 220 is connected to storage 222, which stores an operating system 224 and application software 226 for execution by the server hardware 220.

FIG. 2C illustrates the web server 108. Server hardware 240 is connected to storage 242, which contains the web software 244 and an operating system 246.

FIG. 2D illustrates the EDI server 110. Server hardware 260 is connected to storage 262, which contains the EDI software 264 and an operating system 266.

FIG. 2E illustrates the FTP server 112. Server hardware 280 is connected to storage 282, which holds the FTP software 284 and the operating system 286.

FIG. 2F is illustrative of the various user computers 118, 122, 124 and 126. The client or user hardware 290 is connected to storage 292, which contains an operating system 294 and a web browser 296. This operating system could be Microsoft Windows, Apple OSX or Linux. Exemplary web browsers include Internet Explorer, Firefox, Safari and Opera.

FIG. 2G is illustrative of the document preparation servers 117 and 121. The server hardware 272 is connected to storage 274, which contains an operating system 276, database software 278 with tables 270 and application software 271. The operating system 276 can be Windows or Linux, for example. The database software 278 can be database software such as Microsoft SQL server, Oracle, MySQL or the like. The application software 271 provides the document preparation capability for the relevant import or export documents and accesses the database tables 270 for necessary information as described below.

It is understood that the above examples of hardware, operating systems and exemplary software are provided as examples and it is well understood that other configurations could be utilized. In addition, the connection of the servers in the server network 102 can occur in a different manner and the various functions can be integrated into more or fewer physical servers as desired. It is understood that the various storage items are computer readable media which store computer programs used to cause the related server or computer to perform various operations, including operations according to the present invention.

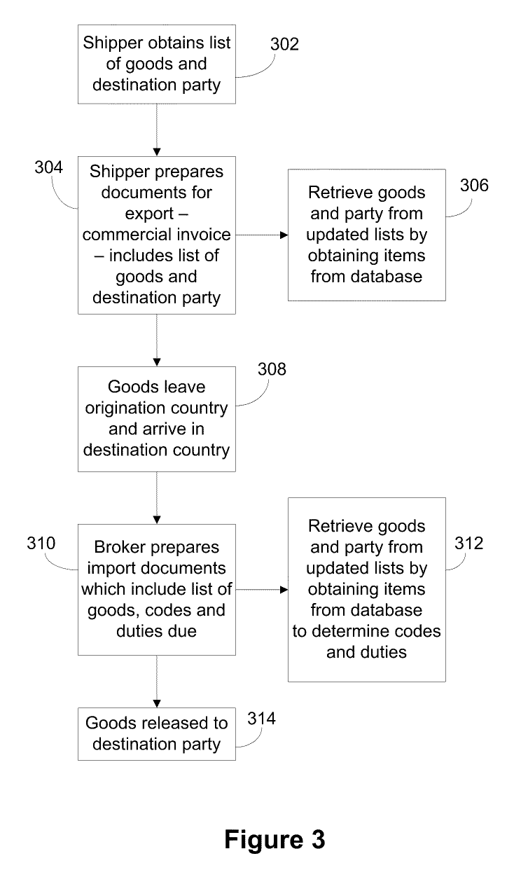

Basic flow according to the preferred embodiment of the present invention occurs as shown in FIG. 3. In step 302 the shipper or exporter obtains a list of goods to be shipped and the destination party. In step 304 the shipper prepares the various documents that are necessary for export, commonly known as a commercial invoice. The commercial invoice includes a list of goods and the destination party. In step 306, as the documents are being prepared for the shipper in step 304, the document preparation server 121 retrieves the relevant goods and party information from its database tables 270. As discussed below, the server network 102 keeps the database tables 270 updated or synchronized so that only current information is contained in them, not outdated information as would be the case in the prior art. In an alternate embodiment, such as where the exporter network 120 is also the server network 102, the information may be retrieved directly from the database server 104. In another alternate embodiment the document preparation server 121 may not contain the goods and party information database but may obtain it directly from the database server 104. After the information is retrieved in step 306, the documents are printed. In step 308 the goods leave the origination country and arrive in the destination country. In step 310 the broker, the importer in this case, prepares import documents, which include the list of goods, relevant codes and any duties due. This list can be developed in many ways and numerous software packages are available. As part of the preparation of the import documents, in step 312 the document preparation server 117 queries its database tables 270 to determine the various codes and duties that are due. As above, this information is kept updated so only the most current information is utilized in preparing the documents. As with the export preparation, alternative embodiments can have the information obtained directly from the database 104, either locally or remotely. In step 314, after the broker has prepared the documents and they have been accepted, the goods are released to the destination party.

Therefore it can be seen that the actual goods and party are checked as the commercial invoice is prepared and as the document used for import is prepared.

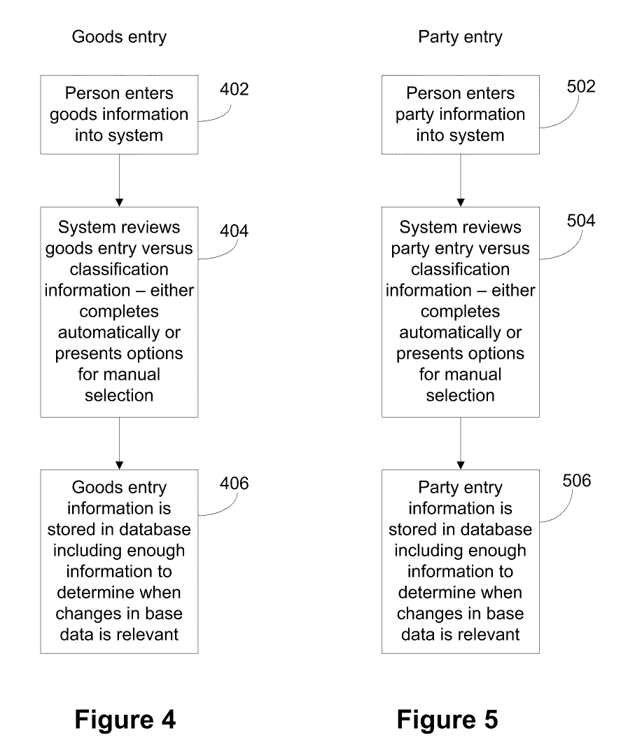

To provide data utilized in the database server 104 it is necessary to enter relevant information as to the goods and to the parties. FIG. 4 illustrates the steps of the goods entry according to the preferred embodiment. An operator or individual in step 402 enters the goods information into the system 100. In step 404 the system 100 reviews the goods entry versus classification information. In some cases the classification data can be stored automatically or options can be presented to the individual for manual selection. Again, various software packages are available to perform or aid in the classification. After the goods are classified in step 406, the goods entry information is stored in the database of the database server 104. The data stored includes the sufficient information to determine when changes in the underlying data used to develop the classification may affect the given entry. One method of providing this underlying data is to maintain the date or version information of the classification information utilized in developing the actual classification. If on a later date the date or version number changes, this would be an indication that it is appropriate to reevaluate the particular good.

FIG. 5 is a similar flowchart for the entry of parties. In step 502 the operator or individual enters the party information into the system 100. In step 504 the system 100, i.e., the application server 106, reviews the party entry versus the classification as is well known. Again this review either completes automatically or options are presented to the individual for manual selection. In step 506 the party information is then stored in the database in the database server 104. Again the sufficient information is maintained in the party entry to allow determination as to the base information utilized and thus is able to be checked for need for updating.

The embodiments of FIGS. 4 and 5 assume individual item entry. In an alternate embodiment, the items can be batch downloaded from a customer ERP server 130, with the operations of FIGS. 4 and 5 occurring in a batch or automated fashion, with manual data entry as needed. After the initial data entry, the ERP server 130 can be checked periodically for changed information and the batch or automated information entry completed for any new or changed entries.

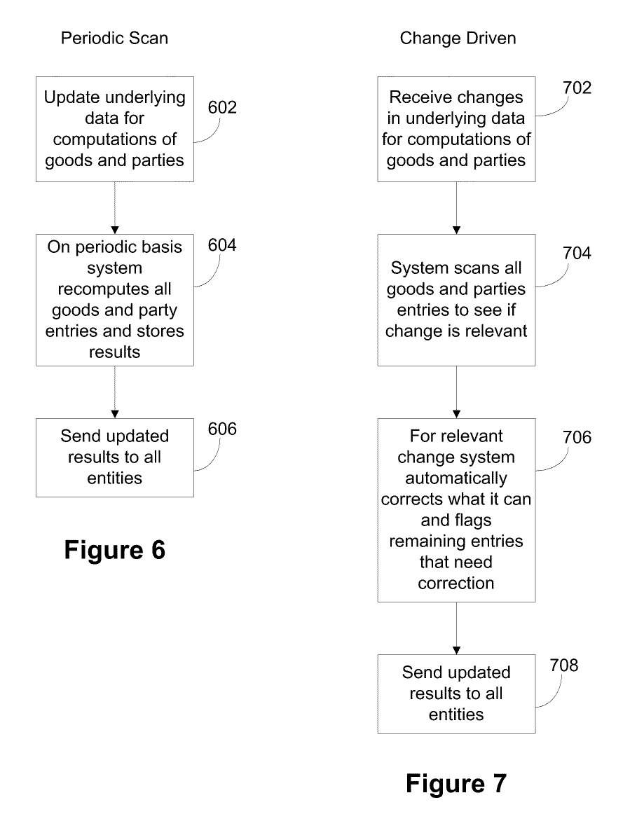

FIG. 6 illustrates a flowchart of one method according to the preferred embodiment for maintaining updated information on goods and the parties. In step 602 the underlying data that is utilized in steps 404 and 504 is updated and records of which underlying data has been changed is maintained. In step 604 on a periodic basis, such as nightly, the system 100 re-computes all goods and all party entries that may need to be changed based on analysis of the information contained in the goods and party entries, such as the dates or version numbers of the classification data with the list of underlying data which has changed. Any necessary entries are computed and the results are stored. In an alternate embodiment all goods and all parties could be recalculated each night or recomputed each period without doing the underlying check. If an update cannot be automatically determined, a list is prepared for manual connection. After the recomputing or updating of step 604 is completed, the updated results are provided to all relevant entities, such as the document preparation servers 117 and 121 so that they are maintained current.

FIG. 7 illustrates an embodiment where necessary changes occur as the underlying data is changed. In step 702 the changes to the underlying data are received. In step 704 the system 100 scans all goods and party entries to see if the change that has just been received in step 702 is relevant to those particular entries. If so, in step 706 the system 100 automatically corrects and updates the various goods and party entries, if possible, and any remaining entries are flagged for manual correction when individual or operators are available. In step 708 the updated results are proved to all relevant entities, as in step 606.

Correlating the various servers 102 with the operations of FIGS. 3-7 is helpful to understand the full information flow inside the preferred embodiment. With respect to FIG. 3, the document preparation of steps 304 and 310 are done on the relevant user station 118, 122 with the aid of the document preparation servers 117 and 121, or with the application server 106 providing web pages to the web server 108 for use by the individuals as in the case of user stations 124 and 126. In the first case the data transfers are only local to the exporter network 120, as the document preparation server 121 contains the updated or current information. In the second case, the necessary data is requested by the application server 106 and provided by the database server 104. The application server 106 performs the checks of steps 306 and 312 and places the data into the web pages provided to the web server 108.

For the goods and party entries of FIGS. 4 and 5, the application server 106 provides web pages to the web server 108, with the pages being displayed on the user stations 118, 122, 124 or 126. The web server 108 provides entered data to the application server 106, which retrieves classification information from the database server 104. The application server 106 then performs the classification and the resulting classification and related information is provided to the database server 104 for storage in the transaction record. In the ERP server 130 case, the FTP server 112 obtains the ERP information from the ERP server 130 and provides it via the EDI server 110 to the application server 106 for processing.

For the updates of FIGS. 6 and 7, the FTP server 112 obtains classification information from the government server 130 and provides it to the EDI server 110. The EDI server 110 reformats the information and provides it to the database server 104. Then either the EDI server 110 or the database server 106 compares the data with that currently stored in the database server 104 and notes any changed data. The changed data is provided to the application server 106, which performs the updates as shown in FIGS. 6 and 7. After the updates are determined, they are provided via the FTP server 112 and the EDI server 110 to the document preparation servers 117 and 121.

Therefore in the preferred embodiment the primary logic functions are performed by the application server 106, with the FTP server 112, EDI server 110, database server 104 and web server 108 acting as interfaces, data storage elements or data gathering elements. It is understood that this partitioning of operations is the preferred embodiment and different partitionings are readily possible, particularly if additional servers are added.

It can be seen that by maintaining sufficient information as to the underlying classification information used to classify a particular good or party updating of this information can be simplified and performed, in general, automatically either periodically or as changes are received. This allows only the most current and most appropriate information to be utilized when the exporter and importer prepare documents rather than outdated information which could delay operations.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A system for maintaining customs compliance, the system comprising:
an entry database server storing a plurality entries for goods and parties, each entry including trade classification information and data providing an indication of underlying information used to develop the trade classification information;
an underlying information database server storing underlying information used to develop goods and party trade classification information;
an update server coupled to the underlying information database server to obtain underlying information from a providing source and to determine if any changes to the stored underlying information have been obtained; and
a recompute server coupled to the entry database server and the update server to recompute trade classification information for any good and party entries in which the underlying information has been changed, the recompute server utilizing the entry data providing an indication of underlying information used to develop the classification information to determine if the underlying information has changed, the recompute server determining updated trade classification information for the entry and providing the updated classification information and data providing an indication of underlying information used to develop the trade classification information to the entry database server for storage.

2. The system of claim 1, further comprising:
a codes and duties database server storing a plurality of entries providing codes and duties for goods and parties.

3. The system of claim 1, wherein a document preparation server may be present at an external location and can be coupled to the recompute server, the document preparation server including a database of goods and party classification information and document preparation software for use by a user, the document preparation software utilizing goods and party classification information from the document preparation server database, and
wherein the recompute server provides the updated classification information to the document preparation server.

4. The system of claim 1, wherein the recompute server recomputes trade classification information on a periodic basis.

5. The system of claim 4, wherein the recompute server recomputes trade classification information for all goods and parties when recomputing trade classification information for any goods and party entries in which the underlying information has been changed.

6. The system of claim 1, wherein the recompute server recomputes trade classification information when the update server determines if there are any changes.

7. The system of claim 1, further comprising:
a goods and parties server coupled to the entry database server, to the entry database server and to the underlying information database server to receive goods and party information, to determine trade classification information for the goods and parties and to provide the entry trade classification information and data providing an indication of underlying information used to develop the trade classification information to the entry database server for storage.

8. The system of claim 7, wherein the goods and parties server is for coupling to external user stations and receives goods and party information from the user stations.

9. The system of claim 7, wherein the goods and parties server is for coupling to an external ERP server,
wherein the goods and parties server receives goods and party information from the ERP server in bulk, and
wherein the goods and parties server processes the received bulk goods and party information in a batch manner.

10. The system of claim 1, wherein the entry database server and the underlying information database server are on a single database server.

11. A method for maintaining customs compliance, the method comprising:
operating an entry database server to store a plurality entries for goods and parties, each entry including trade classification information and data providing an indication of underlying information used to develop the trade classification information;
operating an underlying information database server to store underlying information used to develop goods and party trade classification information;
operating an update server coupled to the underlying information database server to obtain underlying information from a providing source and to determine if any changes to the stored underlying information have been obtained; and
operating a recompute server coupled to the entry database server and the update server to recompute trade classification information for any good and party entries in which the underlying information has been changed, the recompute server utilizing the entry data providing an indication of underlying information used to develop the classification information to determine if the underlying information has changed, the recompute server determining updated trade classification information for the entry and providing the updated classification information and data providing an indication of underlying information used to develop the trade classification information to the entry database server for storage.

12. The method of claim 11, further comprising:
operating a codes and duties database server to store a plurality of entries providing codes and duties for goods and parties.

13. The method of claim 11, wherein a document preparation server may be present at an external location and can be coupled to the recompute server, the document preparation server including a database of goods and party classification information and document preparation software for use by a user, the document preparation software utilizing goods and party classification information from the document preparation server database, the method further comprising:
operating the recompute server to provide the updated classification information to the document preparation server.

14. The method of claim 11, wherein the recompute server recomputes trade classification information on a periodic basis.

15. The method of claim 14, wherein the recompute server recomputes trade classification information for all goods and parties when recomputing trade classification information for any goods and party entries in which the underlying information has been changed.

16. The method of claim 11, wherein the recompute server recomputes trade classification information when the update server determines if there are any changes.

17. The method of claim 11, further comprising:
operating a goods and parties server coupled to the entry database server, to the entry database server and to the underlying information database server to receive goods and party information, to determine trade classification information for the goods and parties and to provide the entry trade classification information and data providing an indication of underlying information used to develop the trade classification information to the entry database server for storage.

18. The method of claim 17, further comprising:
operating the goods and parties server to receive goods and party information from external user stations.

19. The method of claim 17, wherein an external ERP server contains goods and party information, the method further comprising:
operating the goods and parties server to receive goods and party information from the ERP server in bulk, and
operating the goods and parties server to process the received bulk goods and party information in a batch manner.

20. The method of claim 11, wherein the entry database server and the underlying information database server are on a single database server.

21. A computer-readable medium encoded with a computer program for causing a computer or series of computers to perform a method for maintaining customs compliance, the method comprising:
operating an entry database server to store a plurality entries for goods and parties, each entry including trade classification information and data providing an indication of underlying information used to develop the trade classification information;
operating an underlying information database server to store underlying information used to develop goods and party trade classification information;
operating an update server coupled to the underlying information database server to obtain underlying information from a providing source and to determine if any changes to the stored underlying information have been obtained; and
operating a recompute server coupled to the entry database server and the update server to recompute trade classification information for any good and party entries in which the underlying information has been changed, the recompute server utilizing the entry data providing an indication of underlying information used to develop the classification information to determine if the underlying information has changed, the recompute server determining updated trade classification information for the entry and providing the updated classification information and data providing an indication of underlying information used to develop the trade classification information to the entry database server for storage.

22. The computer-readable medium of claim 21, the method further comprising:
operating a codes and duties database server to store a plurality of entries providing codes and duties for goods and parties.

23. The computer-readable medium of claim 21, wherein a document preparation server may be present at an external location and can be coupled to the recompute server, the document preparation server including a database of goods and party classification information and document preparation software for use by a user, the document preparation software utilizing goods and party classification information from the document preparation server database, the method further comprising:
operating the recompute server to provide the updated classification information to the document preparation server.

24. The computer-readable medium of claim 21, wherein the recompute server recomputes trade classification information on a periodic basis.

25. The computer-readable medium of claim 23, wherein the recompute server recomputes trade classification information for all goods and parties when recomputing trade classification information for any goods and party entries in which the underlying information has been changed.

26. The computer-readable medium of claim 21, wherein the recompute server recomputes trade classification information when the update server determines if there are any changes.

27. The computer-readable medium of claim 21, the method further comprising:
operating a goods and parties server coupled to the entry database server, to the entry database server and to the underlying information database server to receive goods and party information, to determine trade classification information for the goods and parties and to provide the entry trade classification information and data providing an indication of underlying information used to develop the trade classification information to the entry database server for storage.

28. The computer-readable medium of claim 27, the method further comprising:
operating the goods and parties server to receive goods and party information from external user stations.

29. The computer-readable medium of claim 27, wherein an external ERP server contains goods and party information, the method further comprising:
operating the goods and parties server to receive goods and party information from the ERP server in bulk, and
operating the goods and parties server to process the received bulk goods and party information in a batch manner.

30. The computer-readable medium of claim 21, wherein the entry database server and the underlying information database server are on a single database server.
